(19) United States
(12) Patent Application Publication
(10) Pub. No.: US 2007/0109415 A1
(43) Pub. Date: May 17, 2007

(54) METHODS AND SYSTEMS FOR ANTI-VIBRATION VERIFICATION FOR DIGITAL IMAGE ACQUISITION APPARATUSES

(75) Inventor: Chia Tse Chang, Taipei City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/558,885

(22) Filed: Nov. 10, 2006

(30) Foreign Application Priority Data
Nov. 11, 2005 (TW) TW94139591

(51) Int. Cl. H04N 5/228

(52) U.S. Cl. 348/208.99; 348/333.02

(57) ABSTRACT

A method for anti-vibration verification in a digital image acquisition apparatus is provided. An animation is shown on a display, simulating that images captured by the digital image acquisition apparatus is vibrating during recording. A video stream comprising multiple images is acquired, where the video stream is acquired by recording the animation with the digital image acquisition apparatus to create the animation. It is determined whether an anti-vibration function of the digital image acquisition apparatus is adequate by sequentially detecting the difference between the images in the video stream.

### BACKGROUND

The present invention relates to apparatus verification, and more particularly, to methods and systems for anti-vibration verification for digital image acquisition apparatuses.

Digital image acquisition apparatuses such as digital cameras, digital video recorders or similar, are typically equipped with anti-vibration systems to prevent blurring of the acquired images. Various solutions such as mechanism compensation, software compensation or similar, are introduced to reduce the vibration caused by shaking of the apparatus. In these anti-vibration systems, however, effectiveness of the anti-vibration feature is difficult to verify.

### SUMMARY

Methods for anti-vibration verification in digital image acquisition apparatuses are provided. An embodiment of a method for anti-vibration verification in a digital image acquisition apparatus comprises the following steps. An animation is shown on a display, simulating that images captured by the digital image acquisition apparatus is vibrating during recording. A video stream comprising multiple images is acquired where the video stream is acquired by recording the animation with the digital image acquisition apparatus to create the animation. It is determined whether an anti-vibration function of the digital image acquisition apparatus is adequate by sequentially detecting the difference between the images in the video stream.

The animation may initially display an object at a default location on the display, and the object is repeatedly moved for a distance in a direction after a time period and is moved back to the default location after the same time period. The color of the object may be a contrast color of the background color in the animation. The number of times the object moves per second may be less than the number of images recorded in the video stream per second. The digital image acquisition apparatus may capture the animation in a stationary status.

The determining step may further comprise the following steps. Locations of the objects in the images are acquired until the entire video stream is completely processed. It is determined whether the difference between the acquired locations in any two adjacent images is less than a predetermined threshold. A difference number representing the number of the images exceeding the predetermined threshold is updated when the difference between the acquired locations exceeds the predetermined threshold. It is determined whether the difference number is less than a tolerance threshold after the entire video stream is completely processed. It is determined that the performance of the anti-vibration function of the digital image acquisition apparatus is adequate when the difference number is less than a tolerance threshold. The tolerance threshold may be equal to number of the images multiplied by a percentage. It is determined that the performance of the anti-vibration function of the digital image acquisition apparatus is inadequate when the difference number is not less than a tolerance threshold. The anti-vibrating extent of the anti-vibration function may be determined contingent upon the moving distance.

A machine-readable storage medium storing a computer program which, when executed by a computer, performs the anti-vibration verification method for a digital image acquisition apparatus is also provided.

Systems for anti-vibration verification in digital image acquisition apparatuses are provided. An embodiment of a system comprises a display, a digital image acquisition apparatus and a processing unit. The display plays an animation simulating images captured by digital image acquisition apparatuses vibrating during recording. The digital image acquisition apparatus captures the animation to generate a video stream comprising multiple images. The processing unit determines whether the performance of the anti-vibration function of the digital image acquisition apparatus is adequate by sequentially detecting the difference between the images in the video stream.

The processing unit may repeatedly acquire locations of the object in two adjacent images among the images until the entire video stream is completely processed, determine whether the difference between the acquired locations is less than a predetermined threshold, update a difference number representing number of images exceeding the predetermined threshold when the difference between the acquired locations exceeds the predetermined threshold, determine whether the difference number is less than a tolerance threshold after the entire video stream is completely processed, determine that the performance of the anti-vibration function of the digital image acquisition apparatus is adequate when the difference number is less than a tolerance threshold, and determine that the performance of the anti-vibration function of the digital image acquisition apparatus is inadequate when the difference number is not less than a tolerance threshold. The success of the anti-vibrating effect of the anti-vibration function may be determined contingent upon the moving distance.

### BRIEF DESCRIPTION OF DRAWINGS

The invention will become more fully understood by referring to the following detailed description with reference to the accompanying drawings, wherein:

FIG. 1 is a diagram of the system architecture of an embodiment of an anti-vibration verification system;

FIG. 2 is a diagram of a hardware environment applicable to an embodiment of a digital image acquisition apparatus;

FIG. 3 is a diagram of a hardware environment applicable to an embodiment of a computer;

FIG. 4 is a schematic diagram of an embodiment of an animation;

FIG. 5 is a flowchart of an embodiment of a method for playing an animation;

FIG. 6 is a flowchart illustrating an embodiment of a method for image inspection;

FIG. 7 is a diagram of a storage medium storing a computer program for anti-vibration verification in digital image acquisition apparatuses.

### DETAILED DESCRIPTION

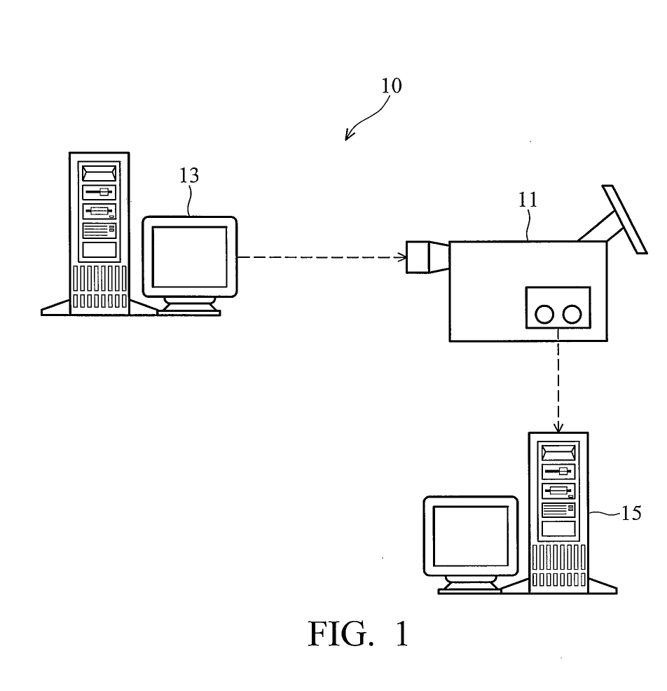

FIG. 1 is a diagram of the system architecture of an embodiment of an anti-vibration verification system 10 comprising computers 13 and 15, and a digital image acquisition apparatus 11 such as a digital camera, digital video recorder or similar. The computer 13 displays a series of images to simulate. The digital image acquisition apparatus 11 records the series of images displayed by the computer 13 in a video file comprising a series of still pictures. The computer 15 loads the video file recorded by the computer 13 and analyzes the difference between pictures therein to determine the ability of the anti-vibration functions provided by the digital image acquisition apparatus 11. Those skilled in the art will realize that the computers 13 and 15 could be integrated in a single computer.

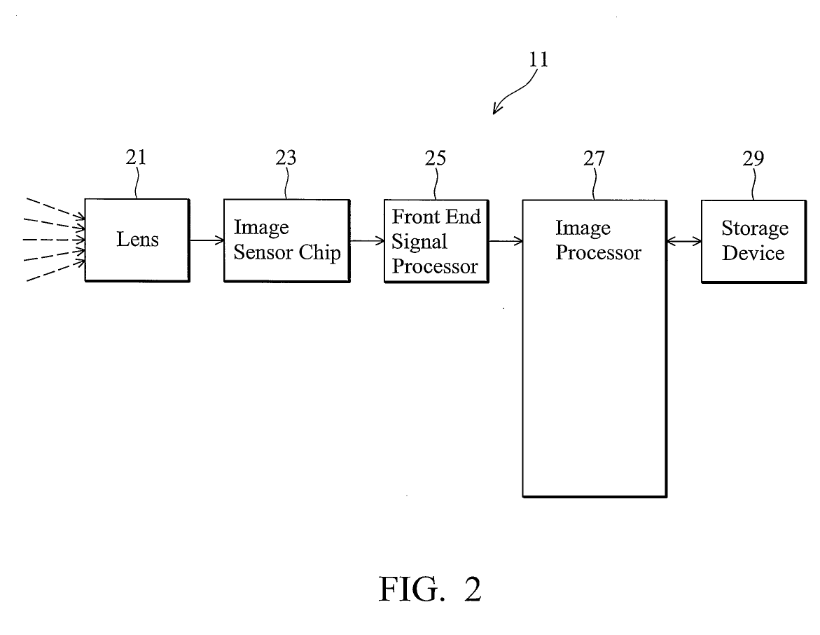

FIG. 2 is a diagram of a hardware environment applicable to an embodiment of the digital image acquisition apparatus 11 comprising lens 21, an image sensor chip 23, a front end signal processor 25, an image processor 27 and a storage device 29. Moreover, those skilled in the art will understand that some embodiments may be practiced with other portable electronic devices, including personal digital assistants (PDAs), mobile phones or similar. The digital image acquisition apparatus 11 records color images as intensities of red, green and blue light, which are stored as variable charges on the image sensor chip 23 such as a complementary metal-oxide semiconductor (CMOS) or a charge-coupled device (CCD) image sensor chip. The charges, which are actually analog, are converted to digital signals by the front end signal processor 25 for storage in the storage device 29 such as flash memory, optical disks, hard disks, or similar. The image processor 27 records the converted digital signals to video streams containing a series of still pictures in a relevant format such as MPEG, audio video interleaved (AVI) or similar.

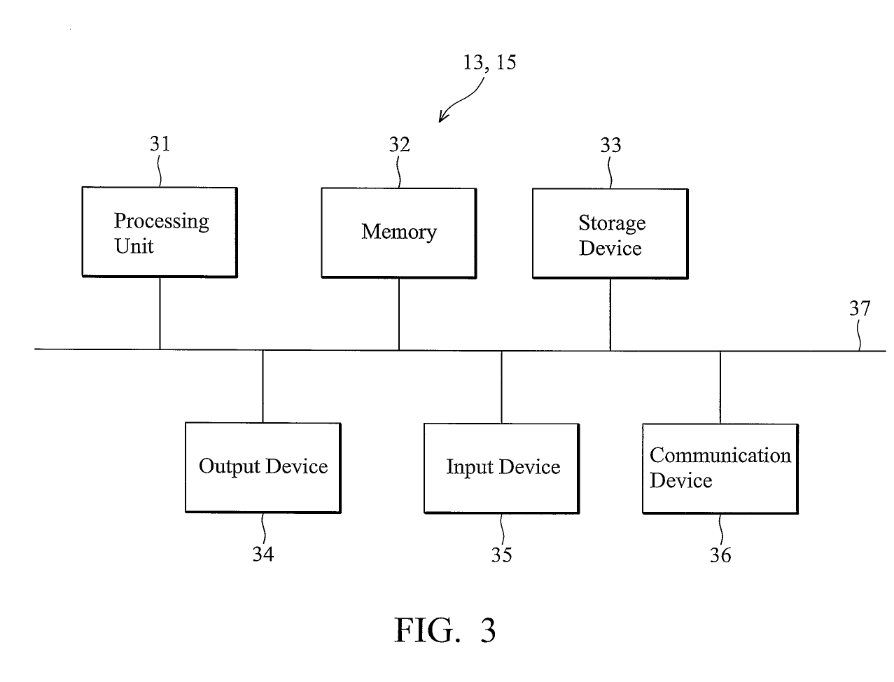

FIG. 3 is a diagram of a hardware environment applicable to an embodiment of computers 13 and 15, comprising a processing unit 31, memory 32, a storage device 33, an output device 34, an input device 35 and a communication device 36. The processing unit 31 is connected by buses 37 to the memory 32, storage device 33, output device 34, input device 35 and communication device 36 based on Von Neumann architecture. There may be one or more processing units 31, such that the processor of the computer comprises a single central processing unit (CPU), a microprocessing unit (MPU) or multiple processing units, commonly referred to as a parallel processing environment. The memory 32 is preferably a random access memory (RAM), but may also include read-only memory (ROM) or flash ROM. The memory 32 preferably stores program modules executed by the processing unit 31 to perform anti-vibration verification functions. Generally, program modules include routines, programs, objects, components, or others, that perform particular tasks or implement particular abstract data types. Moreover, those skilled in the art will understand that some embodiments may be practiced with other computer system configurations, including handheld devices, multiprocessor-based, microprocessor-based or programmable consumer electronics, network PCs, minicomputers, mainframe computers, and the like. Some embodiments may also be practiced in distributed computing environments where tasks are performed by remote processing devices linked through a communication network. In a distributed computing environment, program modules may be located in both local and remote memory storage devices based on various remote access architectures such as DCOM, CORBA, Web objects, Web Services or similar. The storage device 33 may be a hard drive, magnetic drive, optical drive, portable drive, or nonvolatile memory drive. The drives and associated computer-readable media thereof (if required) provide nonvolatile storage of computer-readable instructions, data structures, program modules and/or video files.

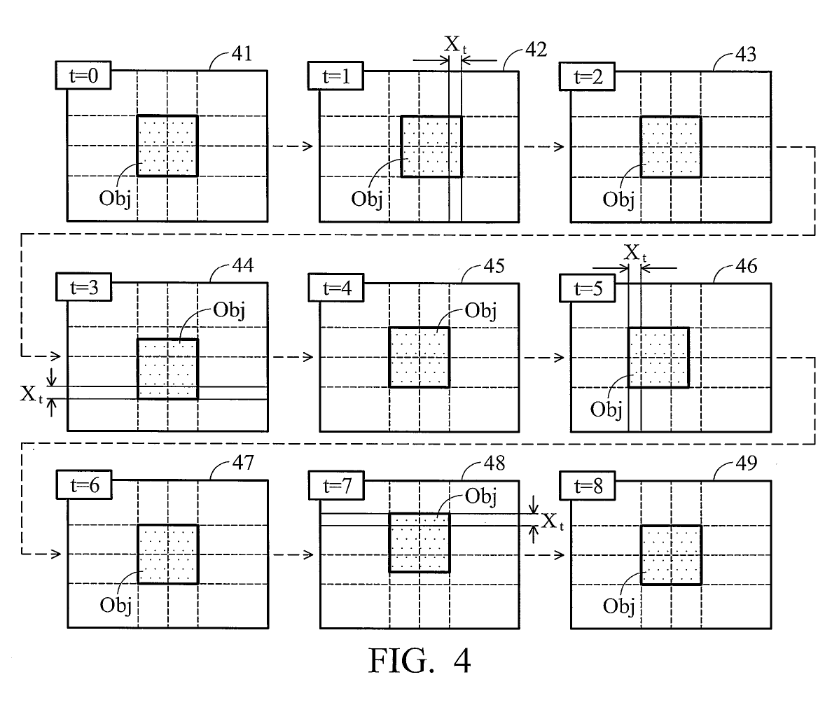

The computer 13 plays an animation on a display such as cathode ray tube (CRT) display, liquid crystal display (LCD), plasma display, organic light-emitting diode display (OLED) or similar, through the output device 34. The animation simulates images captured by a digital image acquisition apparatus vibrating during recording. FIG. 4 is a schematic diagram of an embodiment of an animation comprising a series of sequential images 41 to 49 respectively containing a display object Obj. In general, the display object Obj moves a predetermined distance in a direction after a predetermined time period and moves back to the original position after the same time period. Preferably, the moving distance Xt of the object Obj between two instances is a constant value to facilitate the determination of the anti-vibration extent of the digital image acquisition apparatus 11. The number of times the object Obj moves per second is preferably less than the number of images recorded in the video stream per second. For example, when the number of the images recorded in the video stream is thirty per second, the number of times the object Obj moves may be ten, fifteen, twenty or twenty-five per second. The object Obj may be a geometric pattern such as a circle, rectangle, triangle or similar, filled with a particular color preferably a contrast color of the background color, for example, black against white, red against green, blue against yellow or similar.

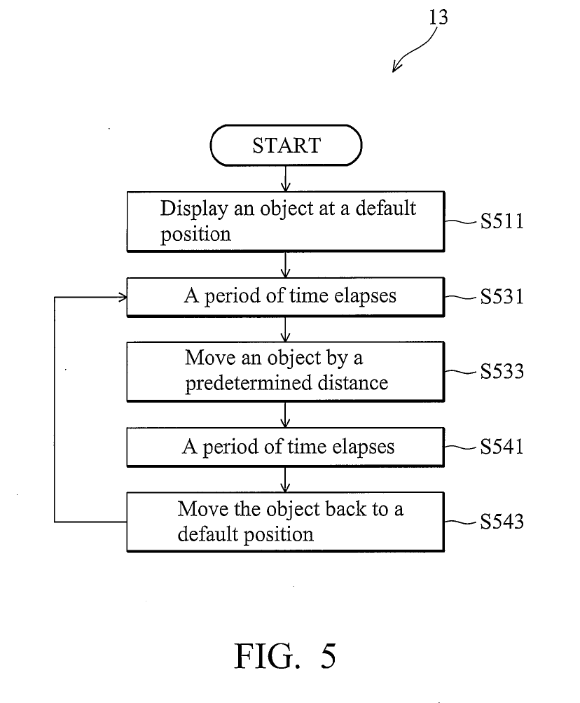

FIG. 5 is a flowchart of an embodiment of a method for playing an animation, performed by the processing unit 31 of the computer 13. In step S51 1, an object Obj is displayed at a default position. In step S53 1, a period of time elapses. In step S533, the object Obj is moved by a predetermined distance. In this step, the object Obj is moved in an arbitrary direction such as up, down, left, right, upper-left, upper-right, lower-left, lower-right or similar. In step S541, a period of time elapses. In step S543, the object Obj is moved back to the default position.

The digital image acquisition apparatus 11 is fixed on a tripod and captures an animation shown on a display as a stationary status, in which the animation simulates images captured by the digital image acquisition apparatus 11 vibrating during recording. A video stream containing recorded images is stored in a video file and the video file is transmitted to the computer 15 by a physical wire connection such as IEEE 1394, universal serial bus (USB), recommended standard-232 (RS-232) or similar, over a network such as a local area network (LAN), wireless LAN, Internet, or from a portable storage medium such as an optical disk, portable drive, hard drive, memory card or similar, for subsequent analysis. When the performance of the anti-vibration function of the digital image acquisition apparatus 11 is adequate, the object Obj in each recorded image is located at a default position or located at a location near the default position.

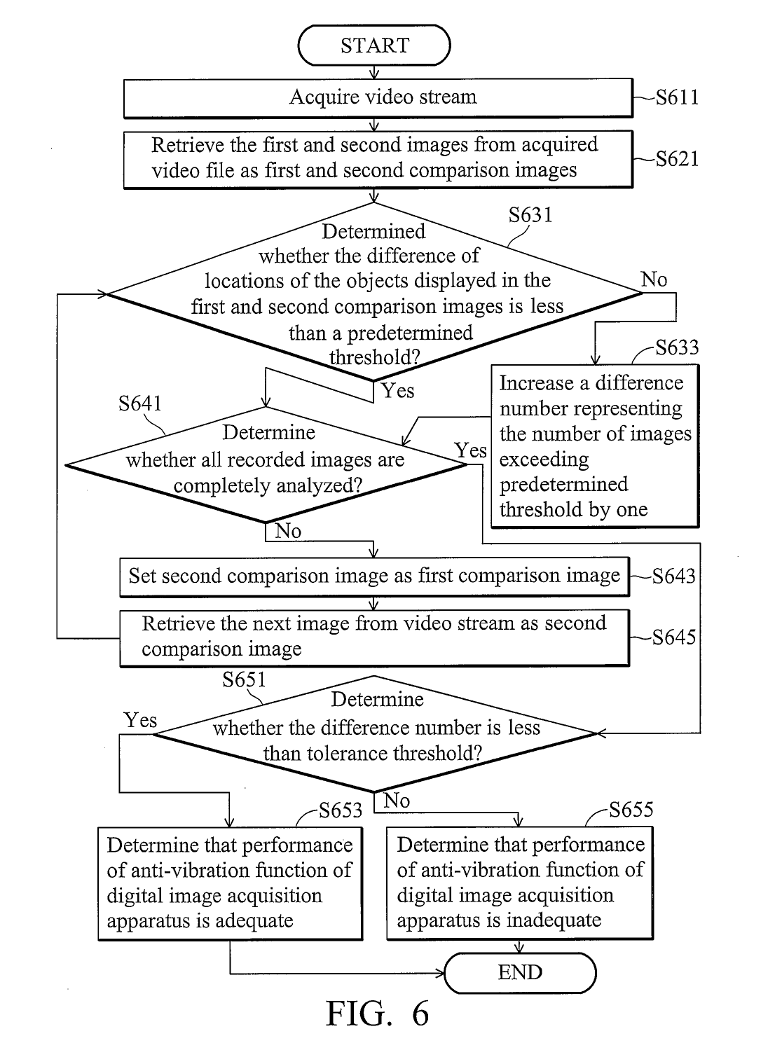

The computer 15 acquires a video stream in a video file and determines the performance of the anti-vibration function of the digital image acquisition apparatus 11 by sequentially detecting the difference of locations of the objects Objs between adjacent images. FIG. 6 is a flowchart illustrating an embodiment of a method for image inspection, performed by the processing unit 31 of the computer 15. In step S611, a video stream is acquired from a video file. In step S621, the first and second images are retrieved from the acquired video file as first and second comparison images. In step S631, it is determined whether the difference of locations of the object Obj displayed in the first and second comparison images is less than a predetermined threshold. If so, the process proceeds to step S641, otherwise, to step S633. In step S633, a difference number representing the number of images exceeding the predetermined threshold is increased by one. In step S641, it is determined whether all recorded images are completely analyzed. If so, the process proceeds to step S651, otherwise, to step S643. In step S643, the second comparison image is set as the first comparison image. In step S645, the next image is retrieved from the video stream as the second comparison image. In step S651, it is determined whether the difference number is less than a tolerance threshold. If so, the process proceeds to step S653, otherwise, to step S655. The tolerance threshold may be a fixed constant or be calculated according to the number of images of the acquired video stream, for example, the tolerance threshold denotes five percent of the number of images. In step S653, it is determined that the performance of the anti-vibration function of the digital image acquisition apparatus 11 is adequate. In step S655, it is determined that the performance of the anti-vibration function of the digital image acquisition apparatus 11 is inadequate. Note that the success of the anti-vibrating effect of the anti-vibration function is determined contingent upon the predetermined distance as shown in step S533 (FIG. 5).

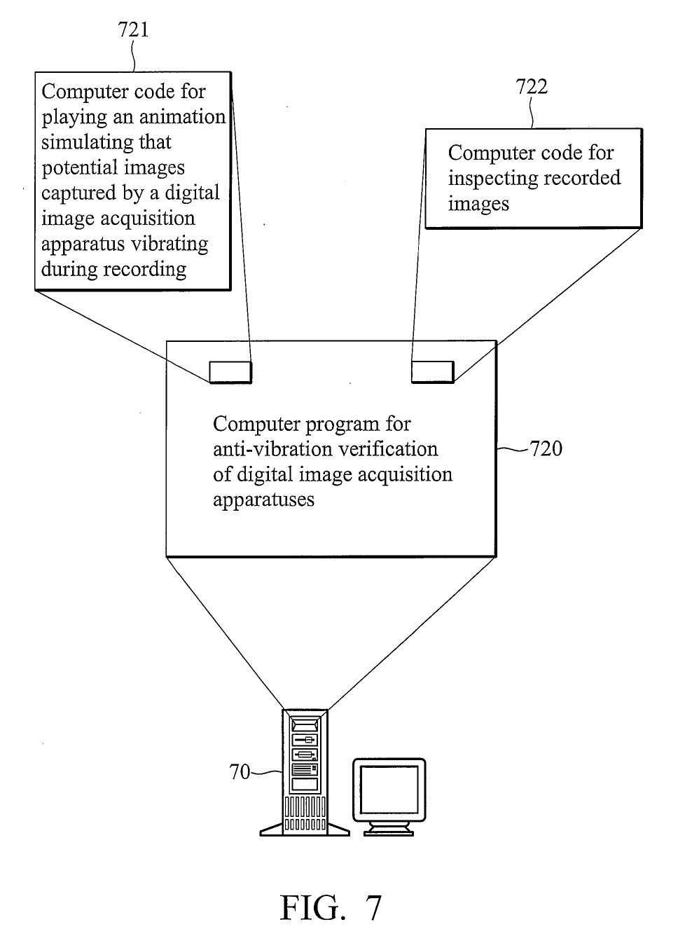

Also disclosed is a storage medium as shown in FIG. 7 storing a computer program 720 providing the disclosed methods for anti-vibration verification of digital image acquisition apparatuses. The computer program includes a storage medium 70 having computer readable program code therein for use in a computer system. The computer readable program code comprises at least an animation computer readable program code 721 playing an animation simulating images captured by a digital image acquisition apparatus vibrating during recording (as shown in FIG. 5), and an inspection computer readable program code 722 inspecting images (as shown in FIG. 6).

Systems and methods for anti-vibration verification for digital image acquisition apparatuses, or certain aspects or portions thereof, may take the form of program code (i.e., instructions) embodied in tangible media, such as floppy diskettes, CD-ROMS, hard drives, nonvolatile memory devices, or any other machine-readable storage medium, wherein, when the program code is loaded into and executed by a machine, such as portable apparatuses and the like, the machine becomes an apparatus for practicing the invention. The disclosed methods and systems may also be embodied in the form of program code transmitted over some transmission medium, such as electrical wiring or cabling, through fiber optics, or via any other form of transmission, wherein, when the program code is received and loaded into and executed by a computer, the machine becomes an apparatus for practicing the invention.

Certain terms are used throughout the description and claims to refer to particular system components. As one skilled in the art will appreciate, consumer electronic equipment manufacturers may refer to a component by different names. This document does not intend to distinguish between components that differ in name but not function.

While the invention has been described in terms of preferred embodiment, it is not intended to limit the invention to the precise embodiments disclosed herein. Those who are skilled in this technology can still make various alterations and modifications without departing from the scope and spirit of this invention. Therefore, the scope of the invention shall be defined and protected by the following claims and their equivalents.

What is claimed is:

1. A method for anti-vibration verification in a digital image acquisition apparatus, comprising:
playing an animation on a display, the animation simulating images captured by the digital image acquisition apparatus vibrating during recording;
acquiring a video stream comprising a plurality of images, where the video stream is acquired by recording the animation with the digital image acquisition apparatus; and
determining whether the performance of an anti-vibration function of the digital image acquisition apparatus is adequate by sequentially detecting the difference between the plurality of images in the video stream.

2. The method as claimed in claim 1 wherein the animation initially displays an object at a default location on the display, and the object is repeatedly moved for a distance in a direction after a time period and moved back to the default location after the same time period.

3. The method as claimed in claim 2 wherein the color of the object is a contrast color of the background color in the animation.

4. The method as claimed in claim 2 wherein the number of times the object moves per second is less than the number of images recorded in the video stream per second.

5. The method as claimed in claim 2 wherein the determining step further comprises:
acquiring locations of the object in the plurality of images until the entire video stream is completely processed;
determining whether the difference between the acquired locations in any two adjacent images of the plurality of images is less than a predetermined threshold;
updating a difference number representing number of images exceeding the predetermined threshold when the difference between the acquired locations exceeds the predetermined threshold;
determining whether the difference number is less than a tolerance threshold after the entire video stream is completely processed;
determining that the performance of the anti-vibration function of the digital image acquisition apparatus is adequate when the difference number is less than a tolerance threshold; and
determining that the performance of the anti-vibration function of the digital image acquisition apparatus is inadequate when the difference number is not less than a tolerance threshold.

6. The method as claimed in claim 5 wherein the tolerance threshold is equal to number of the plurality of images multiplied by a percentage.

7. The method as claimed in claim 2 wherein the anti-vibrating extent of the anti-vibration function is determined contingent upon the distance.

8. The method as claimed in claim 1 wherein the digital image acquisition apparatus captures the animation in a stationary status.

9. A machine-readable storage medium for storing a computer program which, when executed by a computer, performs a method for anti-vibration verification in a digital image acquisition apparatus, the method comprising:
playing an animation on a display, the animation simulating images detected by the digital image acquisition apparatus vibrating during recording;
acquiring a video stream comprising a plurality of images, where the video stream is acquired by recording the animation with the digital image acquisition apparatus; and
determining whether the performance of an anti-vibration function of the digital image acquisition apparatus is adequate by sequentially detecting the difference between the plurality of images in the video stream.

10. A system for anti-vibration verification in digital image acquisition apparatuses, comprising:
a display playing an animation simulating images captured by digital image acquisition apparatuses vibrating during recording;
a digital image acquisition apparatus taking the animation to generate a video stream comprising a plurality of images; and
a processing unit determining whether an anti-vibration function of the digital image acquisition apparatus is acceptable by sequentially detecting the difference between the plurality of images in the video stream.

11. The system as claimed in claim 10 wherein the animation initially displays an object at a default location on the display, and the object is repeatedly moved for a distance in a direction after a time period and moved back to the default location after the same time period.

12. The system as claimed in claim 11 wherein the color of the object is a contrast color of the background color in the animation.

13. The system as claimed in claim 11 wherein of the number of times the object moves per second is less than the number of images recorded in the video stream per second.

14. The system as claimed in claim 11 wherein the processing unit repeatedly acquires locations of the object in two adjacent images among the plurality of images until the entire video stream is completely processed, determines whether the difference between the acquired locations is less than a predetermined threshold, updates a difference number representing number of images exceeding the predetermined threshold when the difference between the acquired locations exceeds the predetermined threshold, determines whether the difference number is less than a tolerance threshold after the entire video stream is completely processed, determines that the performance of the anti-vibration function of the digital image acquisition apparatus is adequate when the difference number is less than a tolerance threshold, and determines that the performance of the anti-vibration function of the digital image acquisition apparatus is inadequate when the difference number is not less than a tolerance threshold.

15. The system as claimed in claim 14 wherein the tolerance threshold equals to number of the plurality of images multiplied by a percentage.

16. The system as claimed in claim 11 wherein the anti-vibrating extent of the anti-vibration function is determined contingent upon the distance.

17. The system as claimed in claim 10 wherein the digital image acquisition apparatus takes the animation in a stationary status.
